(19) United States
(12) Patent Application Publication
(10) Pub. No.: US 2012/0144146 A1
(43) Pub. Date: Jun. 7, 2012

(54) MEMORY MANAGEMENT USING BOTH FULL HARDWARE COMPRESSION AND HARDWARE-ASSISTED SOFTWARE COMPRESSION

(75) Inventor: John M. Borkenhagen, Rochester, MN (US)

(73) Assignee: International Business Machines Corporation, Armonk, NY (US)

(21) Appl. No.: 12/959,482

(22) Filed: Dec. 3, 2010

(51) Int. Cl. G06F 12/00

(52) U.S. Cl. 711/170; 711/E12.001

(57) ABSTRACT

Systems and methods to manage memory are provided. A particular method may include selecting one of a plurality of compression modes to perform memory compression operations at a server computer. The plurality of compression modes may include a first memory compression mode configured to perform a first memory compression operation using a compression engine, and a second compression mode configured to perform a second memory compression operation using the compression engine. At least one of the first compression operation and the second compression operation may be performed according to the selected compression mode.

### I. FIELD OF THE DISCLOSURE

The present disclosure relates generally to computer memory architecture, and in particular, to a system and a method of managing compressed memory.

### II. BACKGROUND

Memory compression may use encoded data represented as symbols to use less memory space. Memory compression effectively expands memory capacity for some applications without increasing actual physical memory and associated expenses. For example, where memory dual in-line memory module (DIMM) slots on a server computer are all populated, memory compression can improve performance by creating an appearance that more memory is populated than is physically possible on the server computer. When implementing memory compression techniques, designers must still account for actual available memory and processing resources. For example, some software compression algorithms that manage memory may burden processor core cycles. Complexities inherent to such designs may limit memory compression usage.

### III. SUMMARY OF THE DISCLOSURE

In a particular embodiment, a method to manage memory includes selecting a compression mode at a server computer from among a plurality of compression modes. The plurality of compression modes may include a full hardware memory compression mode configured to perform a first memory compression operation using a compression engine and first address data determined by hardware. The plurality of compression modes may further include a hardware-assisted software compression mode configured to perform a second memory compression operation using the compression engine and second address data determined by software. At least one of the first compression operation and the second compression operation may be performed according to the selected compression mode.

In another embodiment, a method of managing memory includes selecting one of a plurality of compression modes to perform memory compression operations at a server computer. The plurality of compression modes may include a first memory compression mode configured to perform a first memory compression operation using a compression engine, and a second compression mode configured to perform a second memory compression operation using the compression engine. At least one of the first compression operation and the second compression operation may be performed according to the selected compression mode.

In another embodiment, an apparatus includes hardware logic configured to determine first data on which to perform a first compression operation, and a compression engine in communication with the hardware logic. The compression engine may be configured to perform a first memory compression operation on the first data using first address data determined by the hardware logic. The compression engine may be further configured to perform a second memory compression operation using the compression engine and second address data determined by software.

A particular embodiment may perform a full hardware compression mode, a hardware-assisted software memory compression mode, and a combination compression mode that includes both hardware memory compression operations and hardware-assisted software memory compression operations at the same time. A common compression engine of a single server computer may concurrently execute two or more of the compression modes. Selectively providing multiple compression mechanisms may provide efficient compression performance under all conditions.

Features that characterize embodiments are set forth in the claims annexed hereto and forming a further part hereof. However, for a better understanding of embodiments, and of the advantages and objectives attained through their use, reference should be made to the Drawings and to the accompanying descriptive matter.

### IV. BRIEF DESCRIPTION OF THE DRAWINGS

FIG. 1 is a block diagram of an embodiment of a computing system configured to manage memory using a plurality of memory compression modes;

FIG. 2 is a block diagram illustrating in greater detail the primary software components and resources used to implement a logically partitioned environment consistent with the computing system of FIG. 1;

FIG. 3 is a block diagram of an embodiment of a system that uses hardware components, such as a compression engine, to perform memory compression operations according to multiple compression modes; and

FIG. 4 is a flowchart of an embodiment of a method of managing memory that includes using compressing and decompressing memory by selecting using a plurality of compression modes.

### V. DETAILED DESCRIPTION

A particular embodiment may perform both full hardware memory compression operations and hardware-assisted software memory compression operations. A common compression engine may be configured to execute both the full hardware memory compression and the hardware-assisted software memory compression. Selectively providing multiple compression mechanisms may provide efficient compression performance under all conditions.

A server computer of another particular embodiment may be configured to perform a full hardware compression mode, a hardware-assisted software memory compression mode, and a combination compression mode that includes both hardware memory compression operations and hardware-assisted software memory compression operations at the same time. A compression engine of the server computer may be configured to execute one or more of the full hardware compression mode, the hardware-assisted software memory compression mode, and the combination compression mode.

The full hardware compression mode may include compression operations that are performed exclusively in hardware. Hardware may determine when and what data is compressed or decompressed. The full hardware memory data compression may thus be used for generic applications that were not written to identify data to be compressed. The hardware-assisted compression mode may include software that determines when and what data is compressed by the compression engine. The hardware-assisted software data compression may thus be used by software applications written to identify data to be compressed. The combination compression mode may include both full hardware compression mode and hardware-assisted software compression mode operations. A single server computer may support memory compression for generic and software compression-aware types of applications. The compression operations may be supported simultaneously on the same server, providing efficient compression.

The compression engine may include hardware logic configured to execute a memory compression operation. A memory compression operation may include a memory compression process or a memory decompression process. As such, the compression engine may be configured to generate a compressed or decompressed version of a data pattern. An illustrative compression engine may be included in the hardware logic of a processor, a memory controller, or on a Peripheral Component Interconnect Express (PCIe) card.

A mode register may be used to select one or more of the full hardware compression mode, the hardware-assisted software memory compression mode, and the combination compression mode. For example, software may automatically determine which mode should be used to compress or decompress data. The automatic determination may be based upon a data pattern, a data flag, a simulation, or other analysis. A setting in the mode register made by the software may direct the compression engine to execute a compression operation according to the selected compression mode.

The software may further use a control register of the hardware to initiate hardware compression operations. For example, the software may set a bit in the control register to indicate when the compression engine should begin a compression operation. A status register in the hardware may be used to communicate to the software that the compression operation is complete. For example, software may poll the status register to determine when a compression operation is complete. The hardware logic may additionally or alternatively send an interrupt when the compression operation is complete.

The software may load address and timing information into the hardware. The address information may include a range of data (e.g., one or more addresses) identifying data that is to be compressed or decompressed. The range of data may include a start address, and ending address, or a range of addresses, among other identifying information. The timing information may indicate when the memory compression operation should begin. The software may also provide a target address range to a target register. The target address range may identify where the compressed or decompressed data is to be stored.

Hardware may include digital circuitry configured to perform a memory compression algorithm. The memory compression algorithm may be hard coded (e.g., into a semiconductor die) to perform embedded, computer instructions. The computer instructions may not be user accessible (e.g., read-only) and may not be preloaded. A particular embodiment of hardware may include firmware. Another embodiment may include a dedicated processor optimized to perform memory compression operations. Hardware instructions may not be executed on a computer operating system. Rather, the operating system may execute software that is loaded onto the server computer.

When operating in full hardware compression mode, the compression and decompression of data may be accomplished in logic of the hardware. The hardware logic may determine to which data the memory compression operation is applied. Full hardware memory compression operations may not use processor cycles. The full hardware memory compression mode may support generic software applications, operating systems, and hypervisors.

When operating in hardware-assisted software compression mode, a software application may have access to more information than the hardware with regard to which data should be compressed. Hardware-assisted software memory compression mode may be automatically selected to achieve better performance by selectively compressing data using based on the information. An embodiment of the hardware-assisted software memory compression mode may support software applications, operating systems, and hypervisors having proprietary software that identifies what data should be compressed. The hardware-assisted software memory compression mode may thus include software to direct compression operations. Processor cycles may be unused, and the hardware-assisted software memory compression mode may not alter or modify the hardware. For example, the software may pass on data address and timing information to the compression engine.

The hardware-assisted software compression mode may cause the compression engine to perform the memory compression operation according to the data address and timing information provided (and without further direction) by the software. Hardware-assisted software memory compression may use relatively fewer processor cycles than full software memory compression and may do so in a short time span. Software may communicate with the hardware using a status register to initiate a compression operation and using a status register to monitor completion status.

The combination compression mode may include both full hardware compression mode and hardware-assisted software compression mode operations. Which mode is used may be based on a determination of an address range(s) written to hardware registers. For the example, one or more address ranges in the main memory may be identified to operate with full hardware data compression. The address range(s) for hardware data compression may be stored in address registers within the hardware logic. The address range(s) may be written by the operating system or by the hypervisor at startup or at controlled points during runtime. All addresses outside of the compression address range(s) may be treated as standard uncompressed data and may be unaffected by the hardware logic.

The combination compression mode may concurrently initiate hardware-assisted software memory compression mode processes on address regions that are not designated to be compressed automatically using full hardware compression. Concurrent operations may include operations that occur simultaneously or substantially simultaneously. Software may identify which address range(s) to compress and where to store the compressed data. Software may write the control register to signal the hardware to perform the compression.

When operating in combination compression mode, full hardware compression may have priority access to the compression engine. The compression engine may be used for hardware-assisted software memory compression mode operations when the compression engine is not being used in full hardware compression mode, and there is an outstanding software request.

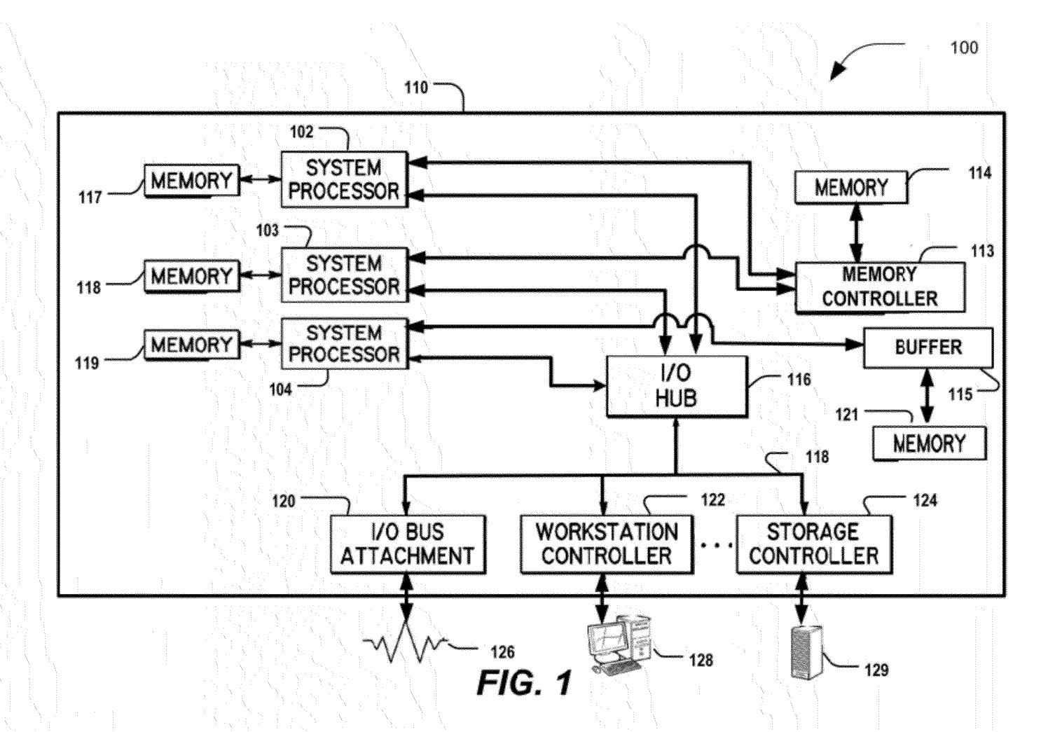

Turning more particularly to the drawings, FIG. 1 illustrates a data processing apparatus 100 configured to selectively perform memory compression mode operations using two or more of a full hardware compression mode, a hardware-assisted compression mode, and a combination mode. The combination mode may include aspects of both the full hardware compression mode and the hardware-assisted compression mode. The apparatus 100 may generically represent any of a number of multi-user computer systems, such as a network server, a midrange computer, and a mainframe computer, among others. Other embodiments may be implemented in another data processing apparatus, e.g., in stand-alone or single-user computer systems, such as workstations, desktop computers, portable computers, and the like, or in other computing devices such as embedded controllers. One implementation of the apparatus 100 may be a multi-user computer, such as the Power Systems computer available from International Business Machines Corporation (IBM).

The apparatus 100 may include physical processors 102-104 coupled to an input/output (I/O) hub 116. A socket of one or more the processors 102-104 may directly and respectively attach to a memory 117-119, e.g., an array of dual in-line memory modules (DIMMs). The physical processors 102-104 may be multithreaded. Multithreading enables the physical processors 102-104 to concurrently execute different portions of program code. The processors 102, 103 may be in communication with a memory controller 113 that is coupled to an additional memory 114. A buffer 115 and an additional memory 121 may be coupled to the processor 104.

The I/O hub 116 may further couple to a number of types of external I/O devices via a system bus 118 and a plurality of interface devices. Illustrative I/O devices include a bus attachment interface 120, a workstation controller 122, and a storage controller 124. Such I/O devices may respectively provide external access to one or more external networks 126, one or more workstations 128, and/or one or more storage devices, such as a direct access storage device (DASD) 129.

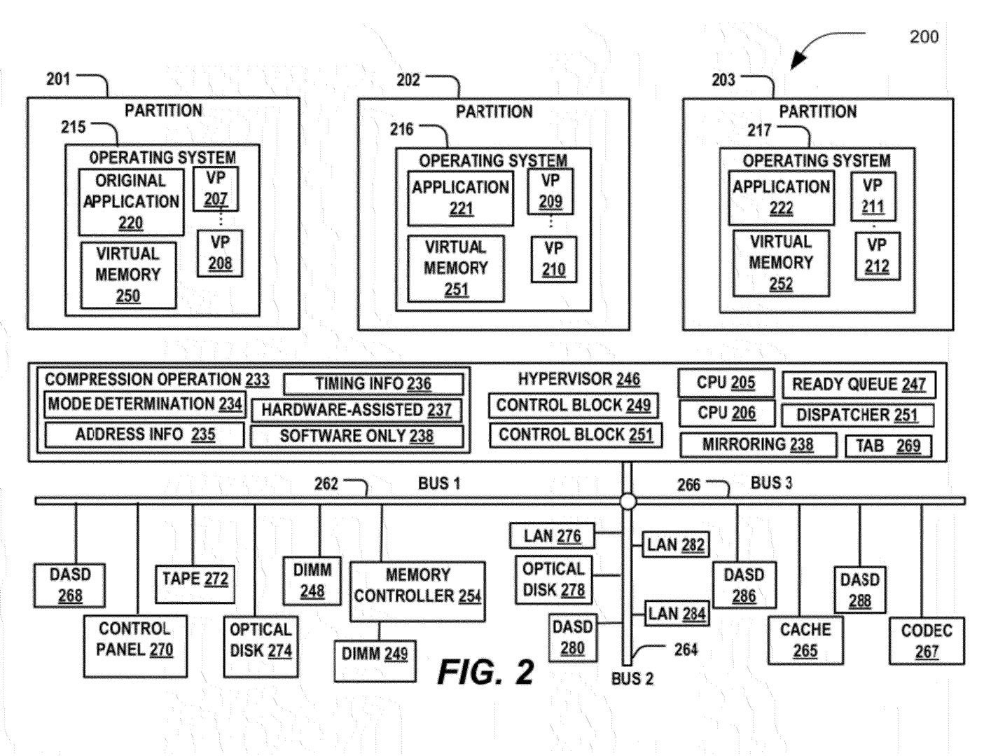

FIG. 2 illustrates in greater detail the primary software components and resources used to implement a logically partitioned environment consistent with the apparatus 100 of FIG. 1. FIG. 2 generally shows a computing architecture characterized as a virtual machine design developed by IBM. The system 200 includes a plurality of partitions 201-203 that share common processing resources among multiple processes. Such an architecture may rely upon a single computing machine having one or more central processing units (CPUs) 205, 206. The CPUs 205, 206 may execute software configured to simulate multiple virtual processors 207-212.

The partitions 201-203 may logically comprise a portion of a system's physical CPUs 205, 206, DASD 268, and other resources, as assigned by an administrator. Each partition 201-203 typically hosts an operating system 215-217 that includes the virtual processors 207-212. Each partition 201-203 may operate as if it is a separate computer. As shown in FIG. 2, the production environment comprising each partition 201-203 may also include program code, such as the applications 220-222 shown in FIG. 2.

An underlying program called a hypervisor 246, or partition manager, may assign physical resources to each partition 201-203. In virtualization technology, the hypervisor 246 may manage the operating systems 215-217 (or multiple instances of the same operating system) on a single computer system. The hypervisor 246 may manage the system's processor, memory, and other resources to allocate resources to each operating system 215-217. For instance, the hypervisor 246 may intercept requests for resources from the operating systems 215-217 to globally share and allocate resources. If the partitions 201-203 are sharing processors, the hypervisor 246 may allocate physical processor cycles between the virtual processors 207-212 of the partitions 201-203 sharing one or more of the CPUs 205, 206.

The hypervisor 246 may include a compression operation module 233 configured to coordinate compression operations with hardware. To this end, the compression operation module 233 may include mode determination program code 234 configured to initiate memory compression operations using one or more of the full hardware compression mode, the hardware-assisted software memory compression mode, and the combination compression mode. The combination compression mode may include both hardware memory compression operations and hardware-assisted software memory compression operations at the same time. The mode determination program code 234 may automatically select which mode should be used to compress or decompress data. The automatic selection may be based upon a data pattern, a data flag, a simulation, or other analysis. The mode may alternatively or additionally be selected in response to received instructions. The mode determination program code 234 may change a setting in a mode register to direct the compression engine to execute a compression operation according to the selected compression mode.

The compression operation module 233 may further include data address information 235 identifying the data to be compressed or uncompressed. The data address information 235 may include an address range, a starting address, an ending address, and/or an amount of data on which a memory compression operation is to be performed by hardware. Compression timing information 236 may be communicated to the hardware and may indicate when the memory compression operation should occur.

Hardware-assisted software compression program code 237 may communicate with the hardware to coordinate hardware-assisted software compression operations. For example, the hardware-assisted software compression program code 237 may communicate the data address information 235 and the compression timing information 236 to the hardware. In a particular embodiment, the system 200 may be configured to conduct software-only data compression operations using software-only program code 238.

The hypervisor 246 may further include a memory minoring algorithm 238 configured to transition from uncompressed, primary memory, (such as may be stored at DIMM 248) to compressed, mirrored memory (e.g., at DIMM 249). The memory minoring algorithm 238 may transition CPU accesses to the mirrored memory when a failure is detected in the primary memory. In another embodiment, a memory mirroring program may be included within an operating system.

Each operating system 215-217 may control the primary operations of its respective logical partition 201-203 in the same manner as the operating system of a non-partitioned computer. Each logical partition 201-203 may execute in a separate memory space, represented by virtual memory 250-252. Moreover, each logical partition 201-203 may be statically and/or dynamically allocate a portion of available resources in the system 200. For example, each logical partition 201-203 may share one or more of the CPUs 205, 206, as well as a portion of the available memory space for use in virtual memory 250-252. In this manner, a given CPU 205, 206 may be utilized by more than one of the logical partitions 201-203.

The hypervisor 246 may include a dispatcher 251 that manages the dispatching of virtual processors 207-212 to the CPUs 205, 206 on a dispatch list, or ready queue 247. The ready queue 247 comprises memory that includes a list of the virtual processors 207-212 having work that is waiting to be dispatched on a CPU 205, 206. The hypervisor 246 shown in FIG. 2 also controls the CPUs 205, 206, and may additionally control a memory controller 254 and the DIMMs 248, 249. Processor control blocks 249 of the hypervisor 246 include memory that includes a list of the virtual processors 207-212 waiting for access on the CPUs 205, 206.

Additional resources, e.g., mass storage, backup storage, user input, network connections, and the like, are typically allocated to one or more logical partitions in a manner well known in the art. Resources may be allocated in a number of manners, e.g., on a bus-by-bus basis, or on a resource-by-resource basis, with multiple logical partitions sharing resources on the same bus. Some resources may be allocated to multiple logical partitions 201-213 at a time. FIG. 2 illustrates, for example, three logical buses 262, 264 and 266, with a plurality of resources on the bus 262, including a direct access storage device (DASD) 268, a control panel 270, a tape drive 272 and an optical disk drive 274, allocated to a partition.

The bus 264 may have resources allocated on a resource-by-resource basis, e.g., with a local area network (LAN) adaptor 276, optical disk drive 278 and a DASD 280 allocated to logical partition 202, and LAN adaptors 282, 284 allocated to logical partition 203. The bus 266 may represent, for example, a bus allocated specifically to the logical partition 203, such that all resources on the bus 266 (e.g., the DASDs 286, 288), are allocated to the same logical partition 203. The hardware shown in FIG. 2 optionally includes one or more caches 265.

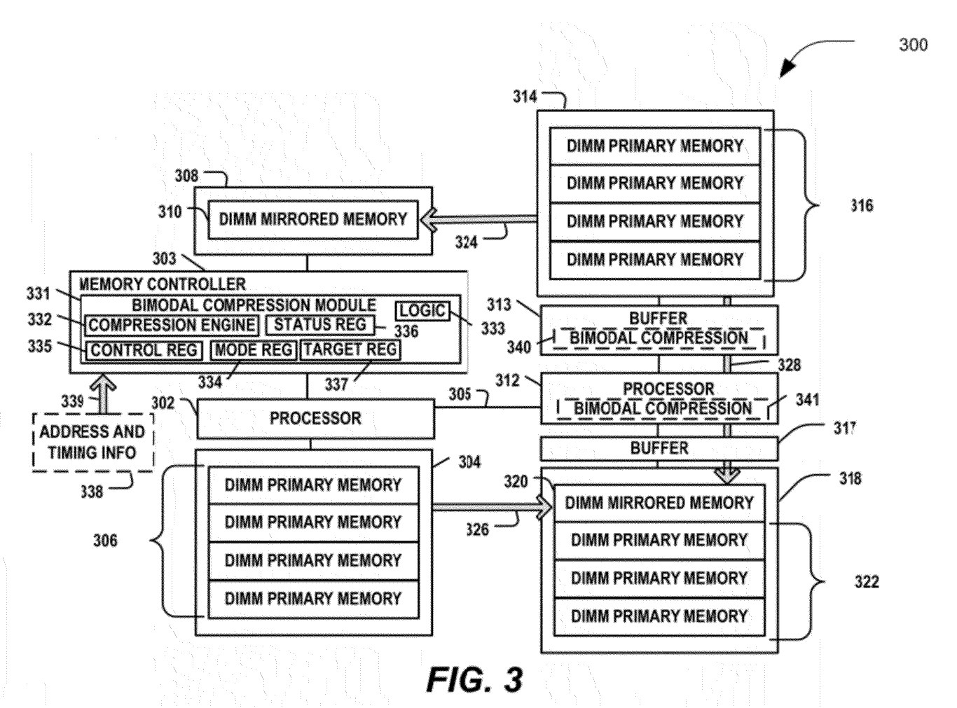

FIG. 3 shows an embodiment of a system 300 configured to conduct memory compression operations using one or more of the full hardware compression mode, the hardware-assisted software memory compression mode, and the combination compression mode. The combination compression mode may include both hardware memory compression operations and hardware-assisted software memory compression operations. The system 300 may include two processors 302, 312 that each has directly attached memory 304, 308, 314, and 318. The processors may be coupled to one another via a processor bus 305. The system 300 may include data in uncompressed, primary memory 306, 316, 322 that may be mirrored in compressed, mirrored memory 310, 320. The processors 302, 312 may be similar to the processors 101-103 of FIG. 1 and to the CPUs 205, 206 of FIG. 2. The memory 304, 308, 314, and 318 may be similar to the memory 117-119 of FIG. 1 and to the DIMMs 248, 249 of FIG. 2.

The system 300 also may include a memory controller 303 and buffers 313, 317. The memory controller 303 may be similar to the memory controller 113 of FIG. 1, and the buffers 313, 317 may each be similar to the buffer 115 of FIG. 1. Hardware of the memory controller 303 of FIG. 3 may include a bimodal compression module 331 having a compression engine 332. The compression engine 332 may include hardware logic configured to execute a memory compression operation. The bimodal compression module 331 may be configured to use the compression engine 332 to selectively execute one or more of the full hardware compression mode, the hardware-assisted software memory compression mode, and the combination compression mode that includes both hardware memory compression operations and hardware-assisted software memory compression operations.

Compression logic 333 of the memory controller 303 may be configured to execute a memory compression operation while in full hardware compression mode. More particularly, the compression logic 333 may determine to which data and when the memory compression operation is applied.

In hardware-assisted software compression mode, the compression engine 332 may receive address and timing information 338, as indicated by arrow 339. The address and timing information 338 may be sent from software, such as the compression operation program of FIG. 2. As such, the address and timing information 338 may correspond to the data address information 235 and compression timing information 236 of FIG. 2. The address and timing information 338 may include a range of data (e.g., one or more addresses) identifying data that is to be compressed or decompressed. The range of data may include a start address, and ending address, or a range of addresses, among other identifying information. The address and timing information 338 may further indicate when the memory compression operation should begin.

When operating in combination compression mode, full hardware compression may have priority access to the compression engine 332. The compression engine 332 may be used for hardware-assisted software memory compression mode operations when the compression engine is not being used in full hardware compression mode, and there is an outstanding software request.

A mode register 334 may be used to select one or more of the full hardware compression mode, the hardware-assisted software memory compression mode, and the combination compression mode. For example, software (e.g., the mode determination program 234 of FIG. 2) may automatically determine which mode should be used to compress or decompress data. The automatic determination may be based upon a data pattern, a data flag, a simulation, or other analysis. A setting in the mode register 334 may direct the compression engine 332 to execute a compression operation according to the selected compression mode.

A control register 335 may be used to initiate a hardware compression operation at the compression engine 332. For example, a bit in the control register 335 may be set to indicate when the compression engine 332 should begin a compression operation. A status register 336 in the bimodal compression module 331 may be used to communicate to the software that the compression operation is complete. For instance, software may poll the status register 336 to determine when a compression operation is complete. The bimodal compression module 331 may additionally or alternatively send an interrupt to the software when the compression operation is complete.

A target address range may be provided to a target register 337. The target address range may identify where the compressed or decompressed data is to be stored.

The memory controller 303 may additionally include a digital circuit external to the first processor 302 that is configured to manage a flow of data between at least two of the processors 302, 312, the buffers 313, 317, and the memories 304, 308, 314, 318. The buffers 313, 317 may be configured to work in conjunction with one or more of the processors 302, 312 to temporarily hold data while it is being moved between at least two of the processors 302, 312, the buffers 313, 317, and the memories 304, 308, 314, 318. The memory controller 303 may be coupled in between the first processor 302 and the second memory 308 that includes a first DIMM mirrored memory 310.

While the bimodal compression module 331 is shown in the memory controller 303 of FIG. 3, another embodiment may include a bimodal compression module elsewhere within the system. For example, a bimodal compression module may alternatively or additionally be included within a processor or a buffer, as represented in dashed blocks 340 and 341.

The buffer 313 may be coupled in between the second processor 312 and the third memory 314 that includes a second array of DIMM primary memory 316. The third buffer 317 may be coupled in between the second processor 312 and the fourth memory 318 that includes the array of DIMM mirrored memory 320 and the third array of DIMM primary memory 322.

In the embodiment of FIG. 3, the first DIMM mirrored memory 310 may mirror the second array of DIMM primary memory 316, as indicated by the arrow 324. The first DIMM mirrored memory 310 may include compressed data. For example, the first DIMM mirrored memory 310 may include a compressed version of the data in the second array of DIMM primary memory 316.

The array of DIMM mirrored memory 320 may minor the first array of DIMM primary memory 306, as indicated by arrow 326. The array of DIMM mirrored memory 320 may include compressed data. For example, the array of DIMM mirrored memory 320 may include a compressed version of the data in the first array of DIMM primary memory 306. The compression ratio of the compressed data in the array of DIMM mirrored memory 320 as compared to the uncompressed data in the first array of DIMM primary memory 306 may be about four to one, as with the first DIMM mirrored memory 310.

As indicated by arrow 328, the array of DIMM mirrored memory 320 may minor the second array of DIMM primary memory 316. For example, one or more of the processors 302, 312 the memory controller 303, and the buffers 313, 317 may replicate and compress data of the second array of DIMM primary memory 316 to be stored in the array of DIMM mirrored memory 320.

One or more of the first processor 302, the second processor 312, the memory controller 303, the buffer 313, and the buffer 317 may include compression logic to compress data when stored in the first DIMM mirrored memory 310 and the array of DIMM mirrored memory 320. At least one of a hypervisor and an operating system, such as the hypervisor 246 and the operating system 215 of FIG. 2, may be configured to control the transition from accessing the second array of DIMM primary memory 316 to accessing the first DIMM mirrored memory 310.

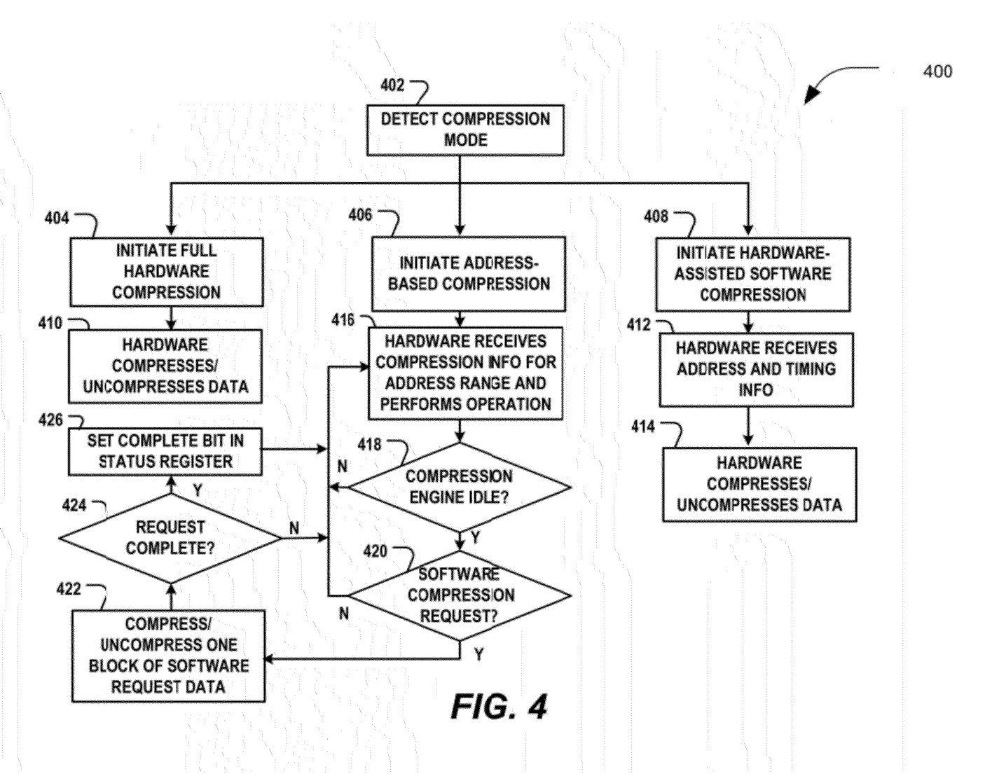

FIG. 4 shows an embodiment of a method 400 of conducting memory compression operations using one or more compression modes. More specifically, the method 400 incorporates the full hardware compression mode, the hardware-assisted software memory compression mode, and the combination compression mode that includes both hardware memory compression operations and hardware-assisted software memory compression operations. The method 400 may use a compression engine of a server computer system, such as one of the systems 100, 200, and 300 of FIGS. 1-3.

Turning more particularly to the flowchart, a system may detect a compression mode at 402. For example, the bimodal compression module 331 of FIG. 3 may check the mode register 334 to determine a most effective compression mode with which to perform a compression operation. Illustrative compression modes may include one or more of the full hardware compression mode, the hardware-assisted software memory compression mode, and the combination compression mode. The combination compression mode may include both hardware memory compression operations and hardware-assisted software memory compression operations. Software may automatically determine which mode should be used to compress or decompress data based upon a data pattern, a data flag, a simulation, or other analysis. A setting in the mode register 334 may direct the compression engine 332 to execute a compression operation according to the selected compression mode.

Full hardware compression mode may be initiated at 404, where detected at 402. When operating in full hardware compression mode at 410, the compression and decompression of data may be accomplished in the hardware. For instance, the logic 333 of the bimodal compression module 331 of FIG. 3 may determine the data to which the memory compression operation is applied at 410 using the compression engine 332.

Where detected at 402, hardware-assisted software compression mode may be initiated at 408. When operating in hardware-assisted software compression mode, software may provide data address and compression timing information to the compression engine at 412. For instance, software may communicate the data address and compression timing information 338 of FIG. 3 to the compression engine 332. The hardware may compress or decompress the data using the provided data address and compression timing information. For example, compression engine 332 may perform a hardware-assisted software compression operation at 414 according to the data address and compression timing information 338.

Where the combination compression mode is detected at 402, initiation processes at 406 may be associated with both full hardware compression mode and hardware-assisted software compression mode operations. Which mode is used may be based on a determination of an address range(s) written to hardware registers. One or more address ranges in the main memory may be identified to operate with full hardware data compression. For example, the address range(s) for hardware data compression may be stored in the hardware logic 333 of FIG. 3. The address range(s) may be written by the operating system or by the hypervisor at startup or at controlled points during runtime. The compression engine 332 may perform a memory compression operation on the identified data at 416.

The combination compression mode may initiate hardware-assisted software memory compression mode processes on address regions that are not designated to be compressed automatically using full hardware compression. At 418 of the flowchart, the system (e.g., the bimodal compression module 331 of FIG. 3) may determine if the compression engine 332 is idle. Where the compression engine 332 is busy (e.g., performing a full hardware compression operation), the compression engine 332 may remain engaged in the current memory compression operation at 416. Where the compression engine 332 is alternatively idle at 418, the system 300 may determine at 420 if a software request has been made. Where no software request is present, the system may continue to wait for and execute full hardware memory operations at 416.

A software request for a memory compression operation, such as may be present at 420, may identify which address range(s) to compress and where to store the compressed data. The address range(s) and target storage information may be used to execute the memory compression operation at 422. For instance, the compression engine 332 of FIG. 3 may receive and use the address and timing information 338 to compress or decompress a block of identified data.

Where the software request is complete at 424, a complete bit may be set in a status register at 426 before returning to 416. For example, the status register 336 in the bimodal compression module 331 of FIG. 3 may be used to communicate to the software that the compression operation is complete. For instance, software may poll the status register 336 to determine when a compression operation is complete. The bimodal compression module 331 may additionally or alternatively send an interrupt to the software when the compression operation is complete.

When operating in combination compression mode, full hardware compression may have priority access to the compression engine. The compression engine may be used for hardware-assisted software memory compression mode operations when the compression engine is not being used in full hardware compression mode, and there is an outstanding software request. As explained above, the full hardware compression mode may have priority access to the compression engine. As such, where the software request is incomplete at 424, the compression engine may be allocated to a full hardware compression at 416.

FIG. 4 thus shows a flowchart of an embodiment of a method 400 of managing memory that includes memory compression operations using one or more a full hardware compression mode, a hardware-assisted software memory compression mode, and a combination compression mode that includes both hardware memory compression operations and hardware-assisted software memory compression operations at the same time. A single server computer may use the common compression engine to execute the memory compression operations. Selectively providing multiple compression mechanisms may provide the best compression performance under all conditions.

Particular embodiments described herein may take the form of an entirely hardware embodiment, an entirely software embodiment or an embodiment containing both hardware and software elements. In a particular embodiment, the disclosed methods are implemented in software that is embedded in processor readable storage medium and executed by a processor, which includes but is not limited to firmware, resident software, microcode, etc.

Further, embodiments of the present disclosure, such as the one or more embodiments may take the form of a computer program product accessible from a computer-usable or computer-readable storage medium providing program code for use by or in connection with a computer or any instruction execution system. For the purposes of this description, a computer-usable or computer-readable storage medium can be any apparatus that can tangibly embody a computer program and that can contain, store, communicate, propagate, or transport the program for use by or in connection with the instruction execution system, apparatus, or device.

In various embodiments, the medium can include an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the data processing system either directly or through intervening I/O controllers. Network adapters may also be coupled to the data processing system to enable the data processing system to become coupled to other data processing systems or remote printers or storage devices through intervening private or public networks. Modems, cable modems, and Ethernet cards are just a few of the currently available types of network adapters.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. For example, an embodiment may include multiple processors connected to a single memory controller, either using separate processor busses from each processor to the memory controller, or using a single shared system bus that is connected to all processors and the memory controller. Thus, the present disclosure is not intended to be limited to the embodiments shown herein but is to be accorded the widest scope possible consistent with the principles and features as defined by the following claims.

1. A method of managing memory, the method comprising:
selecting a compression mode at a server computer from among a plurality of compression modes, wherein the plurality of compression modes include:
a full hardware memory compression mode configured to perform a first memory compression operation using a compression engine and first address data determined by hardware; and
a hardware-assisted software compression mode configured to perform a second memory compression operation using the compression engine and second address data determined by software; and
performing at least one of the first compression operation and the second compression operation according to the selected compression mode.

2. The method of claim 1, wherein the plurality of compression modes further includes a combination compression mode that includes:
a third memory compression operation using the compression engine and third address data determined by the hardware; and
a fourth memory compression operation using the compression engine and fourth address data determined by the software.

3. The method of claim 2, further comprising determining to initiate at least one of the third memory compression operation and the fourth memory compression operation based on a data address range.

4. The method of claim 2, further comprising concurrently performing the third and the fourth memory compression operations.

5. The method of claim 1, further comprising assigning a plurality of priorities associated with the compression engine to the full hardware memory compression mode and to the hardware-assisted software compression mode.

6. The method of claim 1, further comprising using a mode register to direct the execution of at least one of the first compression operation and the second compression operation according to the determined compression mode.

7. The method of claim 1, further comprising using a control register to initiate execution of the second compression operation.

8. The method of claim 1, further comprising using a status register to communicate a status of at least one of the first compression operation and the second compression operation to the software.

9. The method of claim 8, further comprising using the software to poll the status register to determine the status.

10. The method of claim 1, further comprising using the hardware to send an interrupt to the software when at least one of the first compression operation and the second compression operation are complete.

11. A method of managing memory, the method comprising:
selecting one of a plurality of compression modes to perform memory compression operations at a server computer, wherein the plurality of compression modes include a first memory compression mode configured to perform a first memory compression operation using a compression engine, and a second compression mode configured to perform a second memory compression operation using the compression engine; and
performing at least one of the first compression operation and the second compression operation according to the selected compression mode.

12. The method of claim 11, wherein the plurality of compression modes include at least two of: a full hardware memory compression mode, a hardware-assisted software compression mode, and a combination compression mode that includes both a full hardware memory compression operation and a hardware-assisted software memory compression operation.

13. An apparatus comprising:
hardware logic configured to determine first data on which to perform a first compression operation; and
a compression engine in communication with the hardware logic and configured to perform a first memory compression operation on the first data using first address data determined by the hardware logic, wherein the compression engine is further configured to perform a second memory compression operation using the compression engine and second address data determined by software.

14. The apparatus of claim 13, wherein the plurality of compression modes further includes a combination compression mode that includes a third memory compression operation using the compression engine and third address data determined by the hardware, and a fourth memory compression operation using the compression engine and fourth address data determined by the software.

15. The apparatus of claim 13, wherein performing the memory compression operation further includes performing at least one of a compression operation and a decompression operation.

16. The apparatus of claim 13, wherein the hardware includes hard coded instructions embedded in digital circuitry, and the software includes instructions executed by at least one of an operating system and a hypervisor.

17. The apparatus of claim 13, wherein the hardware determines a point at which the first compression operation is performed by the compression engine.

18. The apparatus of claim 13, wherein the compression engine concurrently performs the first memory compression operation and the second memory compression operation.

19. The apparatus of claim 13, further comprising a mode register used to determine a compression mode of a plurality of compression modes, wherein a first compression mode of the plurality of compression modes is associated with the first memory compression operation and a second compression mode of the plurality of compression modes is associated with the second memory compression operation.

20. The apparatus of claim 13, wherein the software determines a point at which the second compression operation is performed by the compression engine.
